(19) United States
(12) Patent Application Publication
(10) Pub. No.: US 2001/0007291 A1
(43) Pub. Date: Jul. 12, 2001

(54) Drive-through transmission for a towing vehicle

(76) Inventors: Hagen Schmidt, Furth (DE); Stefan Gatersleben, Erlangen (DE)

Correspondence Address: Bachman & LaPointe, P.C., Suite 1201, 900 Chapel Street, New Haven, CT, 06510-2802, US

(21) Appl. No.: 09/759,737

(22) Filed: Jan. 16, 2001

(30) Foreign Application Priority Data
Jan. 12, 2000 (DE) 100 00 865.8

(51) Int. Cl. B60K 25/00

(52) U.S. Cl. 180/53.7; 180/53.1

(57) ABSTRACT

A pass-through transmission for a towing vehicle such as a small tractor or the like is adapted to provide a torque-transmitting connection of a power take-off unit of the towing vehicle to a front-mounting implement such as a sweeper brush. The transmission can be temporarily fixed to the underside of the towing vehicle by latching engagement without involving the use of a tool for fixing purposes so that the transmission can be quickly and easily fitted to and removed from the towing vehicle.

### FIELD OF THE INVENTION

The invention relates to a drive-through transmission for a towing vehicle.

In this specification the term towing vehicle is intended to embrace tractors, small-scale tractors and the like vehicles, and in regard to which there may be a wish to mount thereon a front-mounting implement such as a sweeper brush or the like which is to be driven from a drive shaft extension typically in the form of a power take-off unit of the vehicle.

### BACKGROUND OF THE INVENTION

In a typical situation a drive-through transmission for a towing vehicle is fixedly mounted to the underside of the vehicle in question, to provide for the torque-transmitting connection of a drive shaft extension as a power take-off shaft of the towing vehicle to a front-mounting implement such as the above-mentioned sweeper brush. By virtue of the transmission being fixedly mounted to the vehicle, a suitable tool is required for removing the transmission from the vehicle, and correspondingly also for fitting it thereto. It has been generally found that, because the operation for removing the transmission from the vehicle is time-consuming, the transmission will usually remain mounted to the vehicle. That however means that the ground clearance of the vehicle becomes restricted and the overall weight of the vehicle is increased. On the other hand, removal of the transmission from the vehicle is required for example when a cutting or mowing implement is to be mounted to the vehicle.

### SUMMARY OF THE INVENTION

An object of the present invention is to provide a drive-through transmission for a towing vehicle which can be easily and quickly fitted to and removed from the vehicle.

Another object of the present invention is to provide a drive-through transmission for a towing vehicle, which while being of a strong robust structure can be easily fitted to and removed from the vehicle without entailing complicated operating procedures.

Still a further object of the invention is to provide a drive-through transmission for a towing vehicle, which is so designed as not to inhibit the universality of use and operation of the vehicle itself.

In accordance with the principles of the present invention the foregoing and other objects are attained by a drive-through transmission for a towing vehicle such as a small tractor, for the torque-transmitting connection of a drive shaft extension as a power take-off shaft of the towing vehicle to a front-mounting implement such as a sweeper brush, wherein the transmission can be temporarily fixed without the use of a tool to the underside of the towing vehicle.

In a preferred feature of the invention, the transmission has an end portion which in the fitted condition forms the rearward end portion and a second end portion which in the fitted condition forms the forward end portion, and the transmission can be temporarily fixed without a tool to the underside of the vehicle with its forward and rearward end portions.

For that purpose, in accordance with another preferred feature, at its two end portions which are spaced from each other the transmission may have fixing projections which can be brought into hooking or latching engagement with hook elements which project away from the towing vehicle at the underside thereof and which face away from each other.

In accordance with yet another preferred feature of the invention, first and second plates or bars may extend upwardly from the first end portion of the transmission, with first and second mutually axially aligned fixing projections projecting in opposite directions from the plates, which fixing projections can be brought into hooking or latching engagement with associated hook elements on the towing vehicle. The plates may be rigidly secured to the transmission and more specifically to a part of the casing thereof, thereby affording a structurally simple design configuration. However, this arrangement can give rise to problems insofar as, due to tolerances involved, vibration effects and the corresponding generation of noise may occur while the towing vehicle is moving. In order to be able to avoid such unwanted noise-generating vibration, in accordance with a further preferred feature of the invention the two rearward plates may be disposed pivotably movably about a common pivot axis relative to the transmission, being limited in their movement in one direction by an abutment device. A spring device can be provided between the transmission and the two plates, to urge the plates into a condition of bearing against the abutment device when the transmission is not in use. When the transmission which is designed in that fashion with resiliently engaged plates at its rearward end portion is fixed in position between the above-mentioned hook elements which are spaced from each other in the longitudinal direction of the towing vehicle, the spring device is mechanically stressed thereby. During operation of the towing vehicle that mechanical stressing prevents vibration of the transmission which is temporarily fixed without the use of a tool to the underside of the towing vehicle, thereby avoiding the corresponding generation of troublesome noise.

In a further preferred feature of the transmission according to the invention, the forward end portion thereof may be provided with a bow or loop-shaped stirrup member, referred to hereinafter as the bow member, which, when the transmission is mounted to the underside of the towing vehicle, is accessible from the front end thereof and which is pivotable about a pivot axis oriented transversely with respect to the longitudinal direction of the transmission. First and second mutually axially aligned fixing projections may project in opposite directions away from the bow member. The fixing projections on the bow member may be eccentrically displaced with respect to the pivot axis thereof and can be brought into latching engagement with associated hook elements on the towing vehicle.

In a preferred configuration of that arrangement, the pivot axis of the bow member may be formed by first and second mutually axially aligned and mutually facing mounting trunnions which desirably extend rigidly away from the bow member.

Preferably in that arrangement the bow member mounting trunnions are supported in respective ones of mounting clip or eye members provided on a support bracket fixed to the second forward end portion of the transmission.

A further preferred feature of the invention provides that the bow member has a resilient latching projection which in the mounted position of the transmission is accessible from the front end of the towing vehicle. That makes it possible for the bow member or the mounting trunnions which project away from the bow member towards each other to be brought into temporary latching engagement in a reliable and convenient fashion with the associated hook elements at the front end of the towing vehicle. When the transmission according to the invention is in the condition of being fitted to the towing vehicle, the latching projection engages resiliently into a hole which is provided in fixed relationship with the towing vehicle. If the transmission is to be removed from the towing vehicle, it is only necessary for the latching projection to be moved out of that hole. Thereafter the bow member can be pivoted about the bow member pivot axis in order to disengage the mutually axially aligned fixing projections on the bow member from the associated forward hook elements on the towing vehicle.

For the sake of ease of pivotal movement of the bow member about its pivot axis, in such a way as to save time and force, it is desirable for a hand lever to be provided on the bow member, being positioned in such a way as to be accessible from the front end of the towing vehicle. The hand lever can be adjustably and/or releasably secured to the bow member.

Further objects, features and advantages of the invention will be apparent from the description hereinafter of preferred embodiments thereof.

### BRIEF DESCRIPTION OF THE DRAWING

FIG. 1 is a diagrammatic side view of part of a towing vehicle in conjunction with an embodiment of a drive-through transmission according to the invention which is temporarily fixed to the underside of the vehicle, without entailing the use of a tool,

FIG. 2 is a view in the direction of the arrow II in FIG. 1,

FIG. 3 is a side view of the rearward end portion of another embodiment of the transmission according to the invention with limitedly pivotably movable plates and an associated spring device,

FIG. 4 is a view of the transmission viewing in the direction of the arrow IV in FIG. 3, and

FIG. 5 is a view in the direction of the arrow V in FIG. 1 showing the transmission according to the invention in the condition of being temporarily mounted to the towing vehicle of which a portion is shown therein.

### DESCRIPTION OF PREFERRED EMBODIMENTS

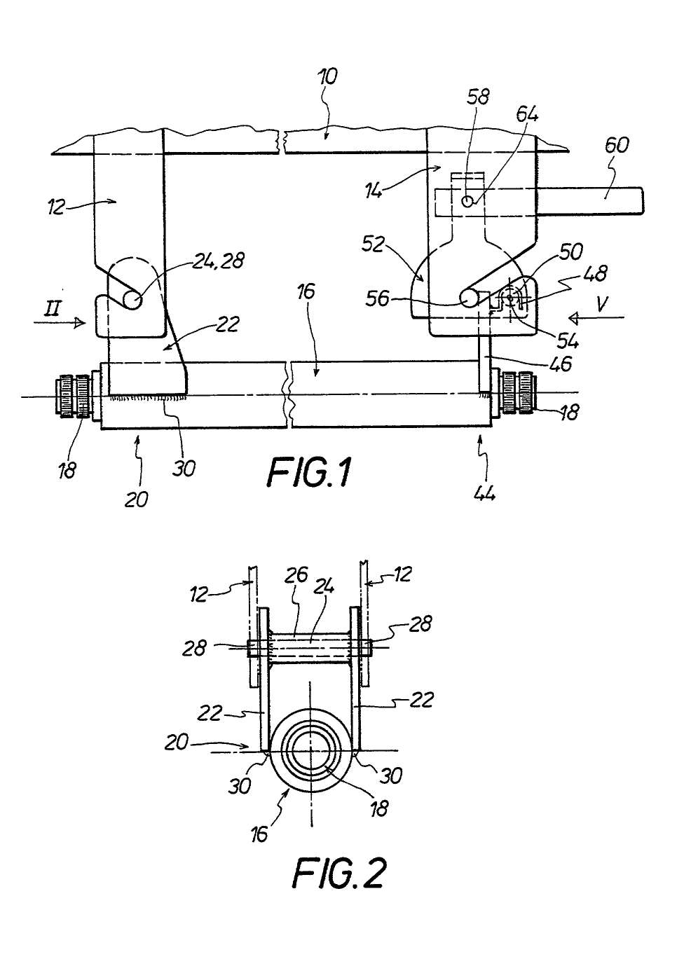

Referring firstly to FIG. 1, shown therein diagrammatically as a side view which is not true to scale is a portion of a towing vehicle generally identified at 10, which may typically be for example a small tractor. Projecting downwardly away from the towing vehicle 10 at the underside thereof are hook elements 12 and 14, with the hook configurations thereof being oriented away from each other, in the manner that can be clearly seen from FIG. 1. The hook elements 12 and 14 are provided for temporarily mounting to the towing vehicle 10 a drive-through transmission which is generally identified by reference numeral 16. The transmission 16 comprises a casing (not referenced), and a connecting shaft which extends through the casing of the transmission 16 and which projects therefrom at the forward and rearward ends thereof to constitute splined shaft trunnions 18. The shaft trunnions 18 with the shaft thereof serve to provide a torque-transmitting connection of a drive shaft extension, for example part of a power take-off unit, of the towing vehicle, to a front-mounting implement such as a sweeper brush or the like.

Reference numeral 20 in FIG. 1 denotes a rearward end portion of the transmission 16. As can also be seen from FIG. 2 in which identical references denote the same components as in FIG. 1, two plates 22 project upwardly in the mounted condition of the transmission 16 from the rearward end portion 20 thereof. A trunnion 24 extends through the two plates 22 and is enclosed by a sleeve 26 provided between the two plates 22. The trunnion 24 extends with its two end portions out of the plates 22 at respective sides thereof, as can be seen clearly from FIG. 2. The ends of the trunnion 24 form fixing projections or pins 28 which are axially aligned with each other and which project in opposite directions. The two fixing projections 28 can be brought into latching engagement with the associated hook elements 12. FIG. 1 shows the assembly in the latched condition.

It will be noted that, in the embodiment shown in FIGS. 1 and 2, the two plates 22 are rigidly fixed to the casing of the transmission 16. That fixing is implemented for example by welds as diagrammatically indicated at 30 in FIG. 1.

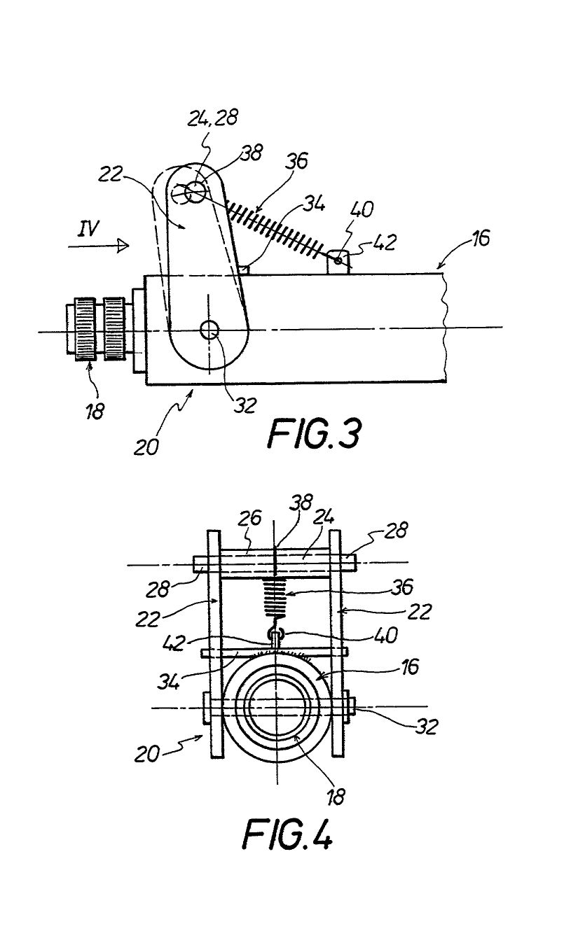

Referring now to FIGS. 3 and 4, shown therein is a part of another embodiment of the transmission 16, which is the rearward end portion 20. The rearward end portion 20 in this embodiment carries a pair of plates 22 which are pivotably movable about a common pivot axis diagrammatically indicated at 32 in FIGS. 3 and 4, relative to the casing of the transmission 16. The pivotal movement of the plates 22 is limited in a first direction by the provision of an abutment device indicated at 34 in FIGS. 3 and 4. Operatively disposed between the casing of the transmission 16 and the plates 22 which are thus pivotable about the pivot axis 32 is a spring device generally identified by reference numeral 36. The spring device 36 urges the plates 22 towards a position of bearing against the abutment device 34 when the transmission 16 is in the condition of not being mounted to a towing vehicle. The spring device 36 which may involve for example at least one coil tension spring is fixed with its one mounting end 38 to the sleeve 26 which encloses the trunnion 24 between the two pivotable plates 22, while its second mounting end which is remote therefrom is fixed to a fixing eye 42 secured to the casing of the transmission 16. In FIG. 3, the two pivotable plates 22 are shown in a solid line in their rest position in which they are urged by the spring device 36 into contact against the abutment device 34, while they are shown in a thin broken line in their position that they adopt when the transmission 16 is mounted to a towing vehicle as indicated at 10 in FIG. 1 and in which the spring device 34 is mechanically stressed in order to prevent vibration and chattering noise when the transmission 16 is in the condition of being mounted to the towing vehicle 10.

It will be appreciated that components in FIGS. 3 and 4 which correspond to those shown in FIGS. 1 and 2 are denoted by the same references.

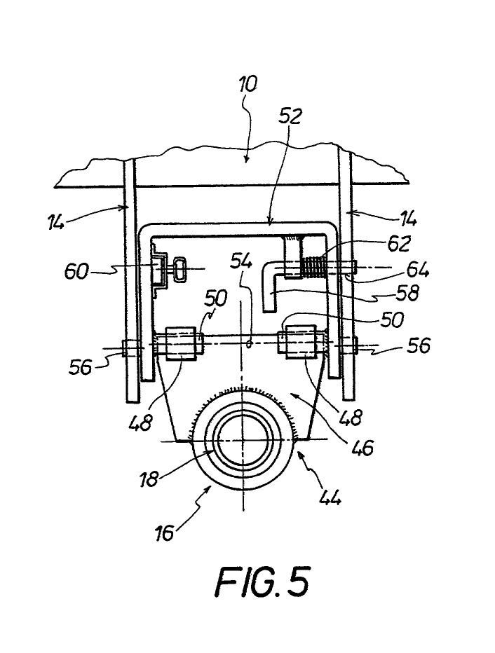

Reference will now again be made to FIG. 1 and also now FIG. 5, from which it will be seen that projecting upwardly from the forward end portion 44 of the transmission 16 is a support bracket 46 from which mounting clip elements 48 project forwardly in FIG. 1, to form mounting recesses or eye configurations. The mounting clip elements 48 serve for temporarily mounting mounting trunnions 50 which project away from a generally U-shaped bow member indicated at 52 in FIGS. 1 and 5, with the mounting trunnions 50 being in mutually axially aligned relationship and projecting towards each other from the mutually facing inward surfaces of the side limbs of the inverted U-shape of the bow member 52, as can be clearly seen from FIG. 5. The mounting trunnions 50 define a pivot axis 54 for the bow member 52, about which the bow member 52 is therefore pivotable. The pivot axis 54 is oriented transversely with respect to the longitudinal direction of the transmission 16.

Reference numeral 56 denotes a pair of mutually axially aligned fixing projections which extend in opposite directions away from the bow member 52 on the outside surfaces of the limbs of the inverted U-shape thereof. The fixing projections 56 are eccentrically displaced with respect to the pivot axis 54, as can be clearly seen from FIG. 1.

When the transmission 16 is in the condition of being mounted to the underside of the towing vehicle 10, which is the condition shown in FIG. 1, the two mutually axially aligned fixing projections 56 are in latching engagement with the associated forward hook elements 14. The transmission 16 can be brought into that position without involving the use of a complicated tool for the fitting operation and conversely also for removal of the transmission 16.

A resilient latching projection 58 and a hand lever 60 are also provided on the bow member 52. In the mounted condition of the transmission 16 the latching projection 58 is engaged by means of the force of a compression spring member 62 into a hole 64 provided in the operatively associated forward hook element 14. This structure and engagement can be clearly seen from FIG. 5. It will be seen therefore that the bow member 52, the hand lever 60 and the latching projection 58 are positioned in such a way as to be readily accessible from the front end of the towing vehicle 10 for the purposes of fitting and removing the transmission.

The hand lever 60 may be mounted to the bow member 52 rigidly or displaceably and/or releasably.

It will be seen that the transmission according to the invention can be fitted to and removed from the underside of a respective towing vehicle such as a tractor in a simple fashion without taking up a great deal of time, and without the use of a special tool for that purpose. When the transmission is fitted to the underside of the towing vehicle 10 its shaft by way of the end shaft trunnions thereof provides the appropriate torque-transmitting connection between the power take-off unit of the towing vehicle and the front-mounting implement which is fitted on the towing vehicle. The transmission according to the invention can be correspondingly easily removed from the underside of the towing vehicle in order for example to provide a suitable free space for a central cutting or mowing mechanism, or to achieve the desired ground clearance under the vehicle. In addition, in the removed condition of the transmission, there is the advantage that the overall weight of the towing vehicle is reduced by the weight of the transmission, which may also be advantageous from energy points of view.

It will be appreciated that the above-described embodiments of the transmission according to the invention have been set forth solely by way of example and illustration of the principles of the invention and that various modifications and alterations may be made therein without thereby departing from the spirit and scope of the invention.

What is claimed is:

1. A drive-through transmission for a towing vehicle for the torque-transmitting connection of a drive shaft member of the towing vehicle to a front-mounting implement, including
means for temporary tool-free fixing of the transmission to the underside of the towing vehicle.

2. A vehicle as set forth in claim 1
wherein the transmission has a first end portion and a second end portion each carrying means for temporarily fixing the transmission without a tool to the underside of the towing vehicle with its first end portion disposed rearwardly of the vehicle and with its second end portion disposed forwardly of the vehicle.

3. A transmission as set forth in claim 2 including
at its spaced end portions fixing projections which are adapted to be brought into hooking engagement with hook elements which project away from the towing vehicle at the underside thereof, the hook configurations of which hook elements face away from each other.

4. A transmission as set forth in claim 3 and further including
first and second plates which in the mounted condition of the transmission extend upwardly from the first end portion of the transmission, and
first and second mutually axially aligned fixing projections which project in opposite directions from said first and second plates, the fixing projections being capable of hooking engagement with the associated hook elements on the towing vehicle.

5. A transmission as set forth in claim 4
wherein the plates are rigidly secured to the transmission.

6. A transmission as set forth in claim 4 including
pivot means mounting the plates to the transmission end portion pivotably movably about a common pivot axis relative to the transmission,
an abutment means limiting the pivotal movement of the plates at one side, and
a spring means operatively disposed between the transmission and said plates and operable to urge the plates towards the abutment means.

7. A transmission as set forth in claim 2 and further including
at said second end portion of the transmission a bow member which is positioned to be accessible from the front of the towing vehicle,
means mounting the bow member to said second end portion pivotably about a pivot axis oriented transversely with respect to the transmission, and
first and second mutually axially aligned fixing projections which project away from the bow member in opposite directions and which are displaced in eccentric relationship with the pivot axis of the bow member and which are adapted to come into hooking engagement with respective hook elements of the towing vehicle.

8. A transmission as set forth in claim 7 wherein
said means mounting the bow member to the second end portion include
first and second mutually axially aligned and mutually facing mounting trunnions on the bow member which define said pivot axis of said bow member and which project rigidly away from same.

9. A transmission as set forth in claim 8 and including
a support bracket on said second end portion of the transmission, and
mounting portions on said support bracket for rotatably accommodating respective ones of said mounting trunnions of said bow member.

10. A transmission as set forth in claim 7 and further including
a resilient latching means on said bow member for resiliently latching the bow member and positioned to be accessible from the front end of the towing vehicle.

11. A transmission as set forth in claim 7 and further including
a hand lever for actuating said bow member and positioned to be accessible from the front end of the towing vehicle.

12. For a tractor comprising a power take-off unit, an underside and support means at the underside of the tractor, a transmission including
a casing,
input means and output means operable for providing a torque-transmitting connection from the power take-off unit of the tractor to an implement to be mounted on the tractor, and
means on the casing for temporarily fixing the transmission to the support means at the underside of the tractor by latching engagement without the use of a tool.
